(19) United States
(12) Patent Application Publication
(10) Pub. No.: US 2021/0400875 A1
(43) Pub. Date: Dec. 30, 2021

(54) CLEANING FAN SYSTEM FOR A FRUIT HARVESTER

(71) Applicant: CNH Industrial America LLC, New Holland, PA (US)

(72) Inventors: Laurent Le Brech, Le Poiré-sur-Vie (FR); Martin Roberge, Saskatoon (CA); Rogelio Chovet, De Pinte (BE)

(21) Appl. No.: 17/281,232

(22) PCT Filed: Sep. 27, 2019
(86) PCT No.: PCT/EP2019/076309

§ 371 Date: Mar. 29, 2021

(30) Foreign Application Priority Data
Sep. 28, 2018 (EP) 18315029.1

(51) Int. Cl. A01D 46/28

(52) U.S. Cl. CPC A01D 46/285

(57) ABSTRACT

A cleaning fan system for use in a fruit harvester includes at least one cleaning fan having an inlet and an outlet. The at least one cleaning fan is configured as a mixed flow fan with a rotor having a frustroconical shaped hub and a plurality of blades. The hub includes a smaller diameter inlet end and a larger diameter outlet end. Each blade is attached to the hub and curves forward from the inlet end toward the outlet end, relative to a direction of rotation of the rotor, whereby air is blown during operation both axially and radially. At least one intake duct includes at least one inlet and an outlet. The inlet is positioned in association with an area to be cleaned on the fruit harvester, and the outlet is coupled with an inlet of a corresponding cleaning fan.

### BACKGROUND OF THE INVENTION

The present invention relates to harvesters for harvesting fruit, such as grapes or olives, and, more specifically to cleaning fans and cleaning fan systems used in such harvesters.

A fruit harvester in the form of a self-propelled grape harvester includes a chassis which carries an onboard power plant and several onboard sub-systems for processing the grapes. The grape harvester straddles and traverses along at least one row of grape vines, and a picking system separates the grapes and Material Other than Grapes (referred to as “MOG”, such as leaves, stems, wood debris, etc.) from the vines. The picking system typically is in the form of “pivotal strikers” or “trunk shakers”. The pivotal strikers can include a double bank of flexible horizontal rods that strike and shake the vine to remove the fruit. The trunk shakers can include parallel skiis oriented on edge that move from side to side to impart horizontal vibration to the vines for removal of the grapes and MOG.

A conveying system transports the grapes and MOG to a cleaning system, which in turn separates the grapes from the MOG and cleans the grapes. The cleaning system can include one or more cleaning fans, a sorting table, and a destemmer.

The sorting table can include a combination of conveying rollers and sorting rollers, which can be optimized for different sizes of grapes. The grapes which are dropped on the conveying rollers are transported to the sorting rollers, where the grapes are sorted from the MOG. The sorting rollers can be configured with an adjustable gap between the sorting rollers such that the grapes fall through and the MOG is transported to the end of the sorting table and discharged.

The destemmer removes the central stalk or stems from the grapes in a cluster/bunch of grapes. A destemmer can include a box or box-like structure which is carried by and moves in an oscillating manner within a frame. The berries (grapes) are supplied to the inlet of the box-like structure, which is shook (aggressively) using an eccentric drive to separate the berries from the stalk and stems. The berries are expelled through holes formed in the in the bottom and top walls of the box, and the rafle (central stalk of the bunch) and stems are expelled at the outlet of the box.

The one or more cleaning fans can be positioned upstream in the cleaning system, and remove larger MOG from the stream of crop material by suction and discharge the larger MOG, such as behind the harvester. Cleaning fans are typically configured as centrifugal fans. A centrifugal fan also is typically noisy during operation. Since modern vineyards may also likely be located in or near to residential neighborhoods, a noisy cleaning fan can be objectionable. A centrifugal fan is a radially operating fan which provides good pressure increase characteristics at the fan outlet, but lacks in mass flow characteristics. The centrifugal cleaning fan receives air axially into the fan inlet, compresses the air, and discharges the air radially from the fan outlet. With the fan positioned above an area to be cleaned, the MOG can be drawn into the fan in a generally vertical direction and discharged from the radial outlet in a general horizontal direction toward the rear of the harvester.

### SUMMARY OF THE INVENTION

The invention is directed to a cleaning fan system for cleaning an area in a fruit harvester, including at least one cleaning fan having an inlet and an outlet. The cleaning fan system is characterized in that the at least one cleaning fan is configured as a mixed flow fan with a rotor having a frustroconical shaped hub and a plurality of blades. The hub includes a smaller diameter inlet end and a larger diameter outlet end. Each of the blades is attached to the hub and curves from the inlet end toward the outlet end, relative to a direction of rotation of the rotor, whereby air is blown during operation both axially and radially. At least one intake duct is provided in association with the at least one cleaning fan, with each intake duct including at least one inlet and an outlet. Each inlet is positioned in association with an area to be cleaned on the fruit harvester, and the outlet is coupled with an inlet of a corresponding cleaning fan.

In a form of the invention, each cleaning fan has a rotor with an axis of rotation, and each cleaning fan is configured with one of a generally horizontal arrangement, a generally vertical arrangement or an inclined arrangement, relative to the corresponding axis of rotation.

In another form of the invention, the at least one cleaning fan comprises a single cleaning fan with a horizontal arrangement, and the at least one intake duct comprises a single intake duct including a split Y configuration with two inlets.

In another form of the invention, each of the two inlets is positioned in association with a lateral conveyor.

In yet another form of the invention, each of the two inlets has a bottom opening and side opening, and further including a pair of material shredders, each said material shredder being located at a respective said inlet.

In yet another form of the invention, the at least one cleaning fan comprises two cleaning fans, each with a horizontal arrangement, and the at least one intake duct comprises two intake ducts, each of the intake ducts being associated with a respective one of the cleaning fans.

In yet another form of the invention, each of the two intake ducts includes an inlet positioned in association with a respective lateral conveyor.

In a further form of the invention, each of the two inlets has a bottom opening and a side opening, and further including a pair of material shredders, each of the material shredders being located at a respective one of the inlets.

In a further form of the invention, each of the intake ducts includes at least one clean out hatch.

In a still further form of the invention, each of the intake ducts is inclined slightly downwardly toward the respective inlet to allow liquid to drain toward the inlet.

In another form of the invention, each cleaning fan is configured with an inclined arrangement, and each cleaning fan has an inlet positioned in association with at least one lateral conveyor.

In another form of the invention, each cleaning fan is configured with a generally vertical arrangement, and each cleaning fan has an inlet positioned in association with at least one lateral conveyor.

In a further form of the invention, one or more discharge ducts are coupled with an outlet of a respective cleaning fan and have a 90° bend.

In a still further form of the invention, the at least one cleaning fan includes a housing having an inlet and an outlet, and an air flow through the at least one cleaning fan at each of the housing inlet and the housing outlet is approximately parallel to an axis of rotation of the hub.

In a still further form of the invention, the housing is configured as a two part housing including an inlet housing portion with a circular shaped housing inlet and an outlet housing portion with an annular shaped housing outlet.

According to another aspect of the invention there is provided a combination of a conveying system and the above cleaning fan system as described above, wherein the conveying system comprising at least one lateral conveyor, and wherein each intake duct includes at least one inlet positioned in association with a respective lateral conveyor.

According to a further aspect of the invention there is provided a fruit harvester comprising the above combination of a conveying system and a cleaning fan system.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is an exploded perspective view of an embodiment of a mixed flow cleaning fan;

FIG. 2 illustrates an embodiment of a cleaning fan system of the present invention, which can include the mixed flow cleaning fan shown in FIG. 1, and has a Y shaped intake duct with two inlets;

FIG. 3 illustrates another embodiment of a cleaning fan system of the present invention, with a cleaning fan configured with a generally horizontal arrangement;

FIG. 4 shows in more detail the intake duct shown on the cleaning fan system of FIG. 3;

FIG. 5 illustrates another embodiment of a cleaning fan system of the present invention, with a cleaning fan configured with an inclined arrangement;

FIG. 6 illustrates another embodiment of a cleaning fan system of the present invention, with a cleaning fan configured with a different inclined arrangement;

FIG. 7 illustrates another embodiment of a cleaning fan system of the present invention, with a cleaning fan configured with a generally vertical arrangement; and

FIG. 8 is a perspective view of the cleaning fan shown in FIG. 7, with an attached discharge duct.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

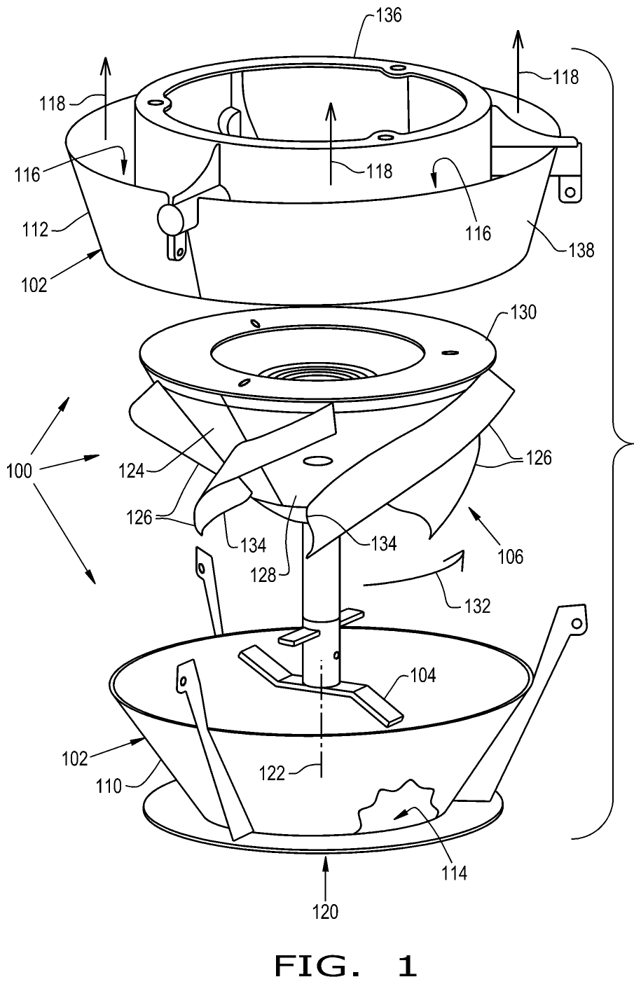

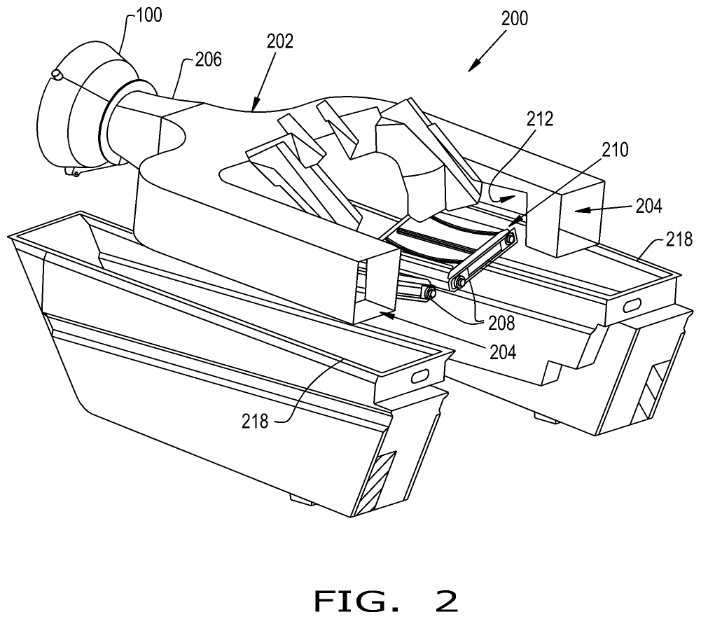

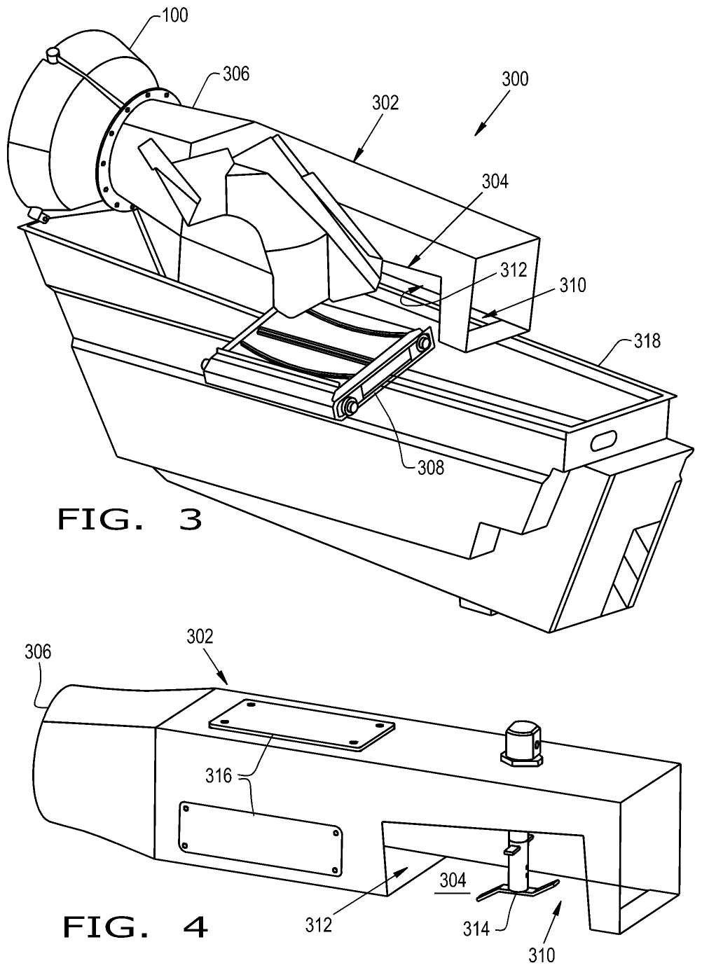

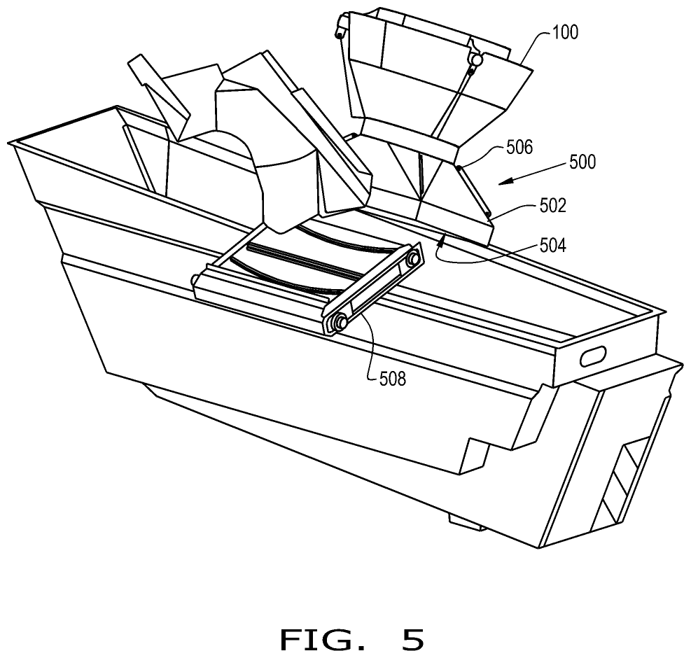

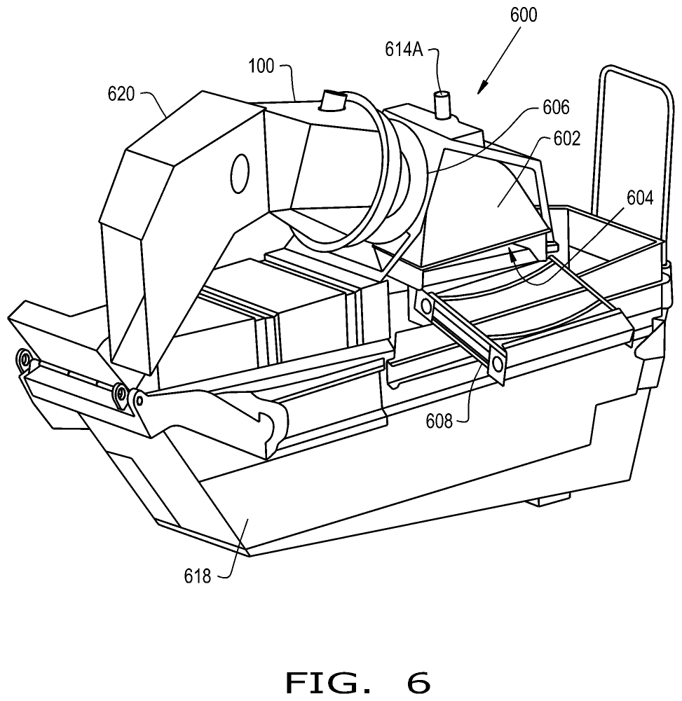

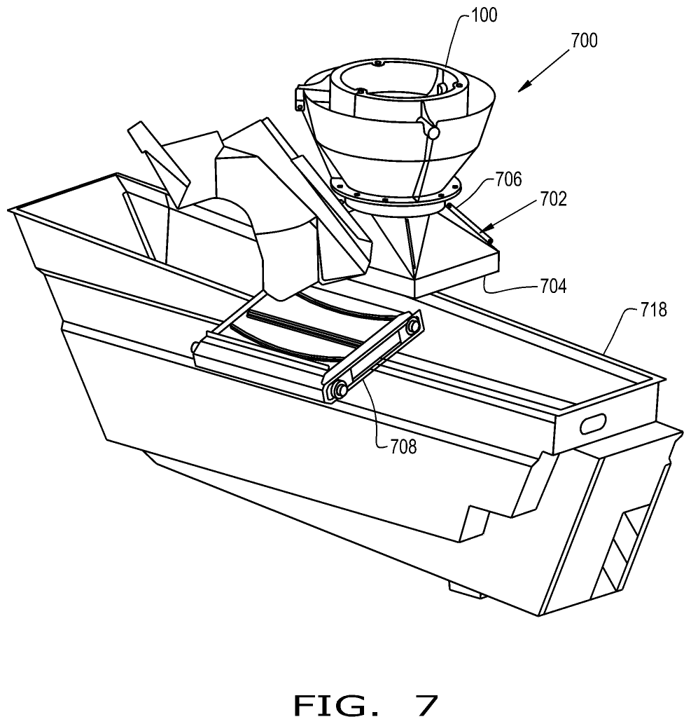

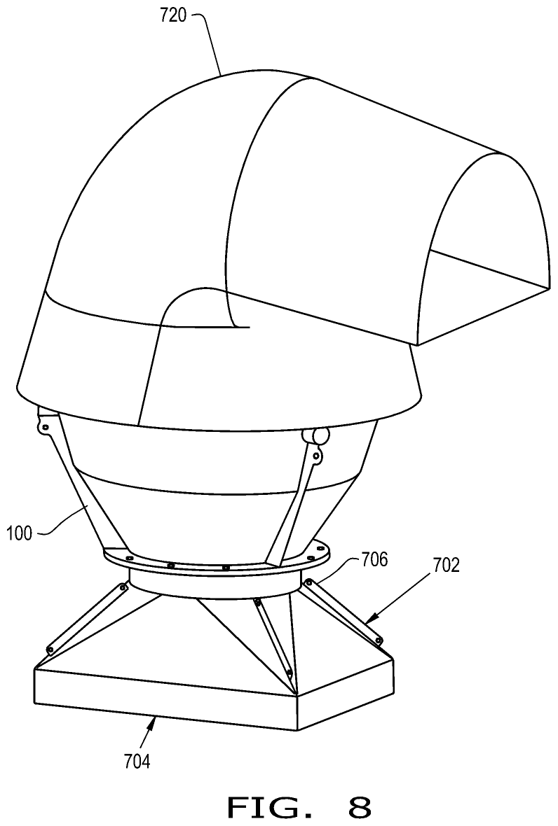

Referring now to FIG. 1, there is shown an embodiment of a cleaning fan 100 of the present invention which can be used with a fruit harvester, such as a grape or olive harvester. The cleaning fan 100 can form part of a cleaning fan system of the present invention, such as the cleaning fan system 200 (FIG. 2), 300 (FIG. 3), 500 (FIG. 5), 600 (FIG. 6) or 700 (FIG. 7).

As indicated above, the cleaning fan 100 removes larger MOG from the stream of crop material by suction and discharges the larger MOG from the harvester. When configured as a grape harvester, the grape bunches or clusters are removed from the grape vines, and conveyed rearwardly and upwardly by suitable conveying mechanisms (not shown). One or more cleaning fans 100 can be located at the upstream end of the cleaning system to remove the MOG.

The cleaning fan 100 generally includes an outer housing 102, a material shredder 104, and a rotor 106. The housing 102 is constructed as a two-piece housing allowing the rotor 106 to be placed therein, including an inlet housing portion 110 and an outlet housing portion 112. The inlet housing portion 110 includes an open circular inlet 114 (partially visible with part of the housing portion 110 fragmented away in FIG. 1) allowing the grapes and MOG to be drawn axially into the rotor 106. The outlet housing portion 112 includes an annular outlet 116 of sufficient cross sectional area to allow discharge of the shredded MOG. In the embodiment shown, the outlet housing portion 112 includes an inner annular housing part 136 which lies closely adjacent to the larger diameter outlet end 130 of the hub 124, and an outer annular housing part 138 which is concentric with the inner annular housing part 136 and defines the annular shaped outlet 116. The flow direction 118 of the MOG from the outlet 116 is generally parallel to the flow direction 120 of the MOG entering the inlet 114 to the inlet housing portion 110, and both flows are generally parallel to the axis of rotation 122 of the rotor 106.

The cleaning fan 100 is configured as a mixed flow fan, combining the high-volume flow characteristics of an axial fan with the increased pressure delivery characteristics of a centrifugal fan. The rotor 106 provides the cleaning fan 100 with mixed flow characteristics, and includes a frustroconical shaped hub 124 and a plurality of blades 126. The hub 124 has a smaller diameter inlet end 128 and a larger diameter outlet end 130. Each of the blades 126 is attached to the hub 124 and curves from the inlet end 128 toward the outlet end 130, relative to a direction of rotation 132 of the rotor 106, whereby air is blown during operation both axially and radially. This combination of axial and radial forces on the air passing through the rotor blades 126 maintains a high flow rate, boosts the air pressure from the outlet of the fan 100, with quiet operating performance.

Each of the blades 126 has a proximal end 134 attached to the hub 124 at or near the inlet end 128, and each of the blades 126 terminates at or near the outlet end 130 of the hub 124. The blades 126 curve in a radial manner toward the outlet end 130, which can be a continuous curve or a stepwise curve with a plurality of adjoining discrete linear segments which generally define a curve.

Referring now to FIG. 2, there is shown an embodiment of a cleaning fan system 200 of the present invention, which can include the mixed flow cleaning fan 100 shown in FIG. 1, and has a single split Y shaped intake duct 202 with two inlets 204 and an outlet 206. Each inlet 204 is positioned in association with an area to be cleaned on the fruit harvester. In the embodiment shown, each inlet 204 is positioned above a respective lateral conveyor 208, but could be positioned at a different location where MOG is to be removed from a flow of crop material. The outlet 206 is coupled with the inlet 114 of the cleaning fan 100. It should be appreciated that a single cleaning fan 100 may be used to remove MOG that enters the two inlets 204 of the intake duct 202 rather than, for example, a cleaning fan associated with each inlet 204, i.e., using two cleaning fans. Using a single cleaning fan 100 to remove MOG, rather than two cleaning fans, may reduce the power requirements and maintenance costs by reducing the number of moving parts. It should be further appreciated that the cleaning fan 100 may be driven by, for example, fluid pressure (hydraulic and/or pneumatic) or electrical power.

Each of the two inlets 204 can be configured with a bottom opening 210 and a side opening 212, providing the inlet with adequate surface area for removal of the MOG from the flow of crop material. An inlet configured in this manner is better visible with respect to the cleaning fan system 300 shown in FIGS. 3 and 4. Each of the two inlets 204 can also be optionally configured with a material shredder, also as shown in FIG. 4. The material shredder chops or shreds the MOG in the flow of crop material, and homogenizes the flow of crop material moving through the intake duct 202 and cleaning fan 100. The homogenized flow of material can improve the flow characteristics through the cleaning fan system 200.

The cleaning fan system 200 shown in FIG. 2 lies generally horizontally, meaning that the cleaning fan 100 and the intake duct 202 both lie generally horizontally. The cleaning fan 100 is configured with a generally horizontal arrangement, whereby the axis of rotation of the rotor 106 lies generally horizontally. Likewise, the intake duct 202 also lies generally horizontally, but can lie at a slight downward angle toward the inlets 204 such that any juice flows toward the inlets into the respective bins 210. A cleaning fan system with a generally horizontal arrangement, such as shown in FIG. 1, has been found to be efficient in terms of power requirements, preventing plugs of crop material in the ducts, etc. It should be appreciated that this generally horizontal arrangement is exemplary only and may be modified to account for different fruit harvester configurations such as, for example, when a destemmer is incorporated.

It can be observed from FIG. 1 that the intake duct 202 includes three areas where the flow of crop material turns at 90° angles prior to entering the cleaning fan 100. However, the turns and curves are provided with sufficient sweep angles and lengths to ensure that crop material does not plug within the intake duct 200. In some embodiments, joints at the intersection of two ducts comprise a flexible material, such as rubber, to allow deformation during unloading of storage bins 218.

Referring now to FIG. 3, there is shown another embodiment of a cleaning fan system 300 of the present invention. With this configuration, two cleaning fans 100 and attached intake ducts 302 are provided, one to each side of the fruit harvester, although only one cleaning fan 100 and attached intake duct 302 are shown in FIG. 3 for brevity and clarity sake. It is to be understood that although only one of the cleaning fans 100 and intake ducts 302 is described herein, the other cleaning fan and intake duct is configured similarly in a mirrored fashion.

The intake duct 302 includes an inlet 304 and an outlet 306. The inlet 304 is positioned in association with an area to be cleaned on the fruit harvester. In the embodiment shown, the inlet 304 is positioned above a lateral conveyor 308 (and the inlet to the other intake duct (not shown) is positioned above the other lateral conveyor). However, the inlet 304 could be positioned at a different location where MOG is to be removed from a flow of crop material. The outlet 306 is coupled with the inlet 114 of the cleaning fan 100.

The inlet 304 can be configured with a bottom opening 310 and a side opening 312, providing the inlet 304 with adequate surface area for removal of the MOG from the flow of crop material. The inlet 304 can also be optionally configured with a material shredder 314, shown in more detail in FIG. 4. The intake duct 302 can also optionally include at least one clean out hatch 316, as shown in FIG. 4. In the illustrated embodiment, the intake duct includes two clean out hatches 316, one located on the top and one on the side. However, the number and location of the clean out hatches can vary from one application to another. The intake duct 302 may include one or more fluid connectors, in addition or alternatively to the clean out hatches 316, such as an internal nozzle that can connect to a source of cleaning fluid, such as a water hose, for cleanup.

The cleaning fan system 300 shown in FIG. 3 lies generally horizontally, meaning that both the cleaning fan 100 and the intake duct 302 lie generally horizontal. The intake duct 302 can be shaped, such as inclined slightly downwardly, toward the inlet 304 to allow liquid to drain toward the inlet 304 and into a storage bin 318 (or externally drained) below. While the intake duct 302 is illustrated as inclined slightly downwardly, it should be appreciated that the shape of the intake duct 302 may be altered to, for example, fit a destemmer or other component, so long as the shape of the intake duct 302 does not suddenly change in its section or direction.

Referring now to FIG. 5, there is shown another embodiment of a cleaning fan system 500 of the present invention, with the cleaning fan 100 configured with an inclined arrangement. With this embodiment, the cleaning fan system 500 includes a short intake duct 502 having an inlet 504 and an outlet 506. The intake duct can have a shape transitioning from the circular inlet of the cleaning fan 100 to any desired shape at the inlet 504 to the intake duct 502, such as the square inlet 504. The inlet 504 is positioned in association with an area where MOG is to be removed from the flow of crop material, and the outlet 506 is attached to the inlet of the cleaning fan 100. In the embodiment shown, the inlet 504 of the intake duct 502 is positioned in association with a lateral conveyor 508.

Referring now to FIG. 6, there is shown another embodiment of a cleaning fan system 600 of the present invention, with the cleaning fan 100 configured with an inclined arrangement. With this embodiment, the intake duct 602 is generally pyramid shaped with an inlet 604 and an outlet 606. The cleaning fan 100 couples at an inclined angle to one of the inclined side walls of the intake duct 602. In the embodiment shown, the inlet 604 of the intake duct 602 is positioned in association with and between a pair of lateral conveyors 608, one of which is visible. An optional material shredder (not visible) can be placed within the intake duct 602, as is apparent by the drive shaft 614A extending from the top of the intake duct 602. A discharge duct 620 is coupled with the outlet 116 of the cleaning fan 100. The discharge duct 620 does not include abrupt changes in direction to avoid excessive power requirements, flow problems, etc, as described above with respect to the intake duct(s). Further, the inclined configuration of the cleaning fan 100 allows a destemmer to fit right under the discharge duct 620.

Referring now to FIGS. 7 and 8, there is shown another embodiment of a cleaning fan system 700 of the present invention, with the cleaning fan 100 configured with a generally vertical arrangement. With this embodiment, the cleaning fan system 700 includes a short intake duct 702 having an inlet 704 and an outlet 706. The intake duct can have a shape transitioning from the circular inlet of the cleaning fan 100 to any desired shape at the inlet 704 to the intake duct 702, such as the square inlet 704. The inlet 704 is positioned in association with an area where MOG is to be removed from the flow of crop material, and the outlet 706 is attached to the inlet of the cleaning fan 100. In the embodiment shown, the inlet 704 of the intake duct 702 is positioned in association with and between a pair of lateral conveyors 708, one of which is visible. A discharge duct 720 can be coupled with the outlet 116 of the cleaning fan 100 (FIG. 8). The discharge duct 720 includes a 90° bend, but is configured with a sweep angle and curve length which avoids abrupt changes in direction.

Any of the cleaning fan systems 200, 300, 500, 600 and/or 700 can be configured with one or more optional material shredders located at or near the inlet to the intake duct(s). The material shredder(s) homogenize the flow of air and MOG which is drawn into the cleaning fan 100. The material shredder(s) can be coupled with and driven by the hub 124 of the cleaning fan 100 (in the case of a short intake duct which is inline with the cleaning fan, as shown in FIG. 5 or 7), or can be separately driven using another power source such as an electric or hydraulic motor.

During operation of the grape harvester, grape bunches including stalks and stems are conveyed rearwardly and upwardly on the harvester for further processing. The cleaning fan 100 is positioned at a suitable location toward the upstream end of the cleaning system, such as at the discharge location onto the upstream ends of the two lateral conveyors. In some embodiments, the harvester is configured so stems that do not include any grapes also fall onto the lateral conveyors for aspiration by the cleaning fan 100. The cleaning fan 100 draws the heavier MOG toward the inlet to the intake duct, and the MOG is then drawn through the intake duct toward the inlet to the cleaning fan. The optional material shredder shreds the MOG into smaller pieces. The mixed flow fan 100 delivers the MOG with improved mass flow and pressure characteristics to the discharge duct, and the MOG is discharged from the discharge duct.

While this invention has been described with respect to at least one embodiment, the present invention can be further modified within the spirit and scope of this disclosure. This application is therefore intended to cover any variations, uses, or adaptations of the invention using its general principles and encompassed by the scope of the claims. Further, this application is intended to cover such departures from the present disclosure as come within known or customary practice in the art to which this invention pertains and which fall within the limits of the appended claims.

1. A cleaning fan system for cleaning an area in a fruit harvester, comprising:
at least one cleaning fan including an inlet, an outlet, a rotor having a frustroconical shaped hub, and a plurality of blades, the hub including a smaller diameter inlet end and a larger diameter outlet end, each of the blades attached to the hub and curving forward from the inlet end toward the outlet end, relative to a direction of rotation of the rotor, whereby air is blown during operation both axially and radially; and
at least one intake duct including at least one inlet and an outlet, the at least one inlet configured for positioning in association with the area to be cleaned, the outlet coupled with the inlet of the at least one cleaning fan.

2. The cleaning fan system according to claim 1, wherein the rotor of the at least one cleaning fan has an axis of rotation, and the at least one cleaning fan is configured with one of a generally horizontal arrangement, a generally vertical arrangement, or an inclined arrangement, relative to the corresponding axis of rotation.

3. The cleaning fan system according to claim 2, wherein the at least one cleaning fan is a single cleaning fan with a horizontal arrangement, and the at least one intake duct is a single intake duct including a split Y configuration with two inlets.

4. A combination comprising a conveying system and a cleaning fan system according to claim 3, wherein each of the two inlets has a bottom opening and side opening, and wherein each of the two inlets includes a material shredder.

5. The cleaning fan system according to claim 2, wherein the at least one cleaning fan comprises two cleaning fans, each having a horizontal arrangement, and the at least one intake duct comprises two intake ducts, each of the two intake ducts being associated with a respective one of the two cleaning fans.

6. The cleaning fan system according to claim 5, wherein the at least one inlet of each of the two intake ducts has a bottom opening and a side opening, and wherein the cleaning fan system further comprises a pair of material shredders, each of the pair of material shredders being located at the at least one inlet of a respective one of the two intake ducts.

7. The cleaning fan system according to claim 5, wherein each of the two intake ducts includes at least one clean out hatch.

8. The cleaning fan system according to claim 5, wherein each of the two intake ducts is inclined slightly downwardly toward the at least one inlet of the each intake duct to allow liquid to drain toward the at least one inlet of the each intake duct.

9. The cleaning fan system according to claim 2, wherein the at least one cleaning fan is configured with a generally vertical arrangement, the cleaning fan system further comprising at least one discharge duct having a 90° bend.

10. The cleaning fan system of claim 2, wherein the at least one cleaning fan is configured with an inclined arrangement.

11. The cleaning fan system of claim 1, wherein the at least one cleaning fan further includes a housing having an inlet and an outlet, and wherein an air flow through the at least one cleaning fan at each of the inlet of the housing and the outlet of the housing is approximately parallel to an axis of rotation of the hub.

12. The cleaning fan system of claim 12, wherein the housing is configured as a two part housing including an inlet housing portion with a circular shaped housing inlet and an outlet housing portion with an annular shaped housing outlet.

13. A combination comprising a conveying system and a cleaning fan system according to claim 1, wherein the conveying system comprises at least one lateral conveyor, and wherein the least one inlet of the at least one intake duct of the cleaning fan system is positioned in association with the at least one lateral conveyor.

14. A fruit harvester comprising a combination of a conveying system and a cleaning fan system according to claim 1.
